(19) United States
(12) Patent Application Publication
(10) Pub. No.: US 2018/0088935 A1
(43) Pub. Date: Mar. 29, 2018

(54) MICROSERVICES APPLICATION CONFIGURATION BASED ON RUNTIME ENVIRONMENT

(71) Applicant: CA, Inc., Islandia, NY (US)

(72) Inventors: Dann M. Church, Castle Rock, CO (US); Mark W. Emeis, Monument, CO (US); Craig Andrew Vosburgh, Colorado Springs, CO (US); Robert C. Hendrich, Colorado Springs, CO (US); James D. Engquist, Colorado Springs, CO (US)

(21) Appl. No.: 15/277,692

(22) Filed: Sep. 27, 2016

(51) Int. Cl. G06F 9/44; G06F 9/445; G06F 11/30

(52) U.S. Cl. CPC G06F 8/71; G06F 8/35; G06F 11/302; G06F 11/3051; G06F 8/60

(57) ABSTRACT

In one embodiment, a microservice container of a microservices application may be launched. The runtime environment of the microservices application may be monitored to identify one or more microservice resources to configure for the microservices application. A microservice resource to configure for the microservices application may be identified based on the runtime environment of the microservices application, and the microservice resource may be configured based on the runtime environment of the microservices application. In some embodiments, one or more additional microservice resources may be configured until determining, based on the runtime environment of the microservices application, that configuration of the microservices application is complete.

### BACKGROUND

The present disclosure relates in general to the field of software development, and more specifically, to configuring applications based on their runtime environment.

As software applications become increasingly sophisticated, their complexity also increases, along with the number and variety of underlying components. Developing a complex software application may be challenging, as its numerous components must each be developed, configured, tested, and maintained. Configuring a software application, for example, may become very difficult as the number of its underlying components increases. Configuring the application may involve tailored configurations for each underlying component. Moreover, because the various components of the application may be developed by different development teams and/or entities, the manner of configuring each component may vary. Accordingly, ensuring that the components of a complex software application are properly configured may be challenging.

### BRIEF SUMMARY

According to one aspect of the present disclosure, a microservice container of a microservices application may be launched. The runtime environment of the microservices application may be monitored to identify one or more microservice resources to configure for the microservices application. A microservice resource to configure for the microservices application may be identified based on the runtime environment of the microservices application, and the microservice resource may be configured based on the runtime environment of the microservices application. In some embodiments, one or more additional microservice resources may be configured until determining, based on the runtime environment of the microservices application, that configuration of the microservices application is complete.

### BRIEF DESCRIPTION OF THE DRAWINGS

FIG. 1 illustrates a simplified schematic diagram of an example computing environment for software applications.

FIG. 2A illustrates a simplified block diagram of an example software development system.

FIG. 2B illustrates a simplified block diagram of an example software registry.

FIG. 3 illustrates an example of runtime-based application configuration.

FIG. 4A illustrates an example monolithic architecture for a software application.

FIG. 4B illustrates an example microservices architecture for a software application.

FIG. 5 illustrates an example software container environment.

FIG. 6 illustrates an example application modeling and development tool.

FIG. 7 illustrates a flowchart for an example embodiment of runtime-based application configuration.

Like reference numbers and designations in the various drawings indicate like elements.

### DETAILED DESCRIPTION

As will be appreciated by one skilled in the art, aspects of the present disclosure may be illustrated and described herein in any of a number of patentable classes or contexts, including any new and useful process, machine, manufacture, or composition of matter, or any new and useful improvement thereof. Accordingly, aspects of the present disclosure may be implemented entirely as hardware, entirely as software (including firmware, resident software, micro-code, etc.), or as a combination of software and hardware implementations, all of which may generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain or store a program for use by, or in connection with, an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, CII, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on a user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider), or in a cloud computing environment, or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses, or other devices, to produce a computer implemented process such that the instructions which execute on the computer or other programmable apparatus provide processes for implementing the functions/acts specified in the flowchart and/or block diagram block or blocks.

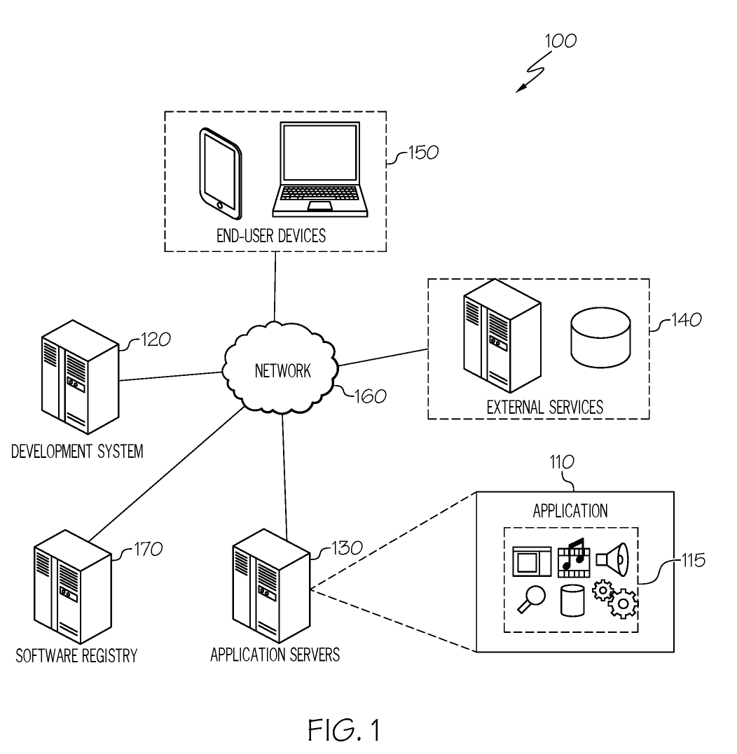

FIG. 1 illustrates a simplified schematic diagram of an example computing environment 100 for software applications. In some embodiments, computing environment 100 may include functionality for runtime-based application configuration, as described throughout this disclosure. The illustrated computing environment 100 includes software application 110, application servers 130, external services 140, software development system 120, and software registry 170, among other hardware and software computing elements. In some implementations, functionality of the various illustrated components, and other associated systems and tools, may be combined or even further divided and implemented among multiple different systems.

Application 110 may be any type of software that is developed and/or hosted in computing environment 100. For example, application 110 may be a software application, program, library, module, or portion of a larger, multi-tiered software system (collectively referred to herein as a software “component”). Application 110 may be developed using software development system 120. In addition, application 110 may be hosted or deployed on one or more application servers 130. Application 110 may be implemented using a monolithic architecture, a microservices architecture, or any other software design approach. A monolithic application may be implemented as a single application that integrates all associated components and functionality. A microservices application may be implemented using multiple separate and self-contained applications, or microservices 115, that each provide a particular service and collectively form a fully functional application. A microservices architecture may allow each underlying microservice 115 of an application 110 to be independently developed, deployed, updated, and scaled, resulting in numerous efficiencies in the software development process. In some cases, an application 110 may also be implemented using software containers (e.g., Docker containers, Open Container Initiative (OCI) based containers, and/or any other software container implementation). Analogous to shipping containers, software containers may package a particular software component with all of its dependencies to ensure that it runs the same in any environment or infrastructure, out-of-the-box. For example, a software container may package everything required to run a particular software component, such as the code, software libraries, configuration, files, runtime environment, and any other associated tools or applications. Software containers may also share a host operating system, thus avoiding the inefficiencies of virtual machines which each require their own guest operating system on top of the host operating system. Microservices applications may be implemented using software containers, for example, by packaging each microservice 115 of an application 110 into separate software containers.

Application servers 130 may host software developed using software development system 120, such as software application 110. Application servers 130 may provide a server environment for running the application 110 and interfacing with its end-users 150. For example, application servers 130 may host web applications for websites, mobile back-ends for mobile applications, databases, and service-based applications (e.g., applications that provide services to other applications), among other examples. Applications 110 hosted on application servers 130 may utilize, consume data and services of, provide data or services to, or otherwise be at least partially dependent on, or function in association with, one or more other software components or applications hosted on the same server system (e.g., application server 130) or a different server system (e.g., external services 140). Applications 110 may be hosted on systems of a single entity or may be distributed among systems controlled by one or more third parties, among other examples.

External services 140 may be third party services used by application 110. For example, external services 140 may be implemented by software components and/or databases hosted by a third party to provide a particular service, such as cloud services, audio and video streaming, messaging, social networking, mapping and navigation, user authentication, payment processing, news, and weather, among other examples. In some embodiments, external services 140 may be hosted by third parties using application servers and/or database servers.

Software development system 120 may facilitate development, configuration, testing, deployment, and/or maintenance of software, such as software application 110. For example, development system 120 may include tools and functionality for use in the software development cycle, including integrated development environments (IDE), application modeling, configuration, version control, compiling, testing, debugging, runtime monitoring, deployment, and maintenance, among other examples. Systems and services that facilitate software development (e.g., development system 120 and software registry 170) may be provided local to, or remote from (e.g., over network 160), the end-user devices 150 of software developers, and/or the target systems used to host the software (e.g., application servers 130 and external services 140).

Software registry 170 may host a repository of software packages that can be used by or used with a particular software application 110, including software libraries or environments, application programming interfaces (APIs), other software applications or components (e.g., database servers, web servers), and operating systems, among other examples. For example, application 110 may rely on a variety of existing software packages, and during development of application 110, development system 120 may obtain the appropriate software packages for building application 110 from software registry 170. Throughout the life of the application 110, development system 120 may also obtain any new versions, releases, updates, patches, bug fixes, or other revisions to those associated software packages. Software packages hosted by software registry 170 may be stored, in some embodiments, using software images corresponding to particular software packages. For example, software packages that are implemented using software containers may be stored in software registry 170 using container images, which may include all components and dependencies required to run a particular software package in a software container. A container image may be a file format used to package the components and dependencies of a containerized software package, such as Docker container images, Open Container Initiative (OCI) based images, and/or any other container image format.

End-user devices 150 may include any type of device that allows a user to interact with the components of computing environment 100. For example, software developers may utilize end-user devices 150 to develop software (e.g., application 110) using software development system 120. As another example, users of a software application 110 may utilize end-user devices 150 to access the application. End-user devices 150 may interact with components of computing environment 100 either locally or remotely over a network 160. For example, in some embodiments, software developers may utilize end-user devices 150 that are local to or integrated with the development system 120, while in other embodiments software developers may utilize end-user devices 150 that interact with the development system 120 over a network 160. End-user devices 150 may include, for example, desktop computers, laptops, tablets, mobile phones or other mobile devices, wearable devices (e.g., smart watches, smart glasses, headsets), smart appliances (e.g., televisions, audio systems, home automation systems, refrigerators, washer/dryer appliances, heat-ventilation-air-conditioning (HVAC) appliances), and the like.

One or more networks 160 may be used to communicatively couple the components of computing environment 100, including, for example, local area networks, wide area networks, public networks, the Internet, cellular networks, Wi-Fi networks, short-range networks (e.g., Bluetooth or ZigBee), and/or any other wired or wireless communication medium. For example, users of application 110 may access the application remotely over a network 160 on application servers 130 using end-user devices 150. As another example, application 110 may utilize external services 140 that are accessed remotely over a network 160. As another example, software developers may access development system 120 remotely over a network 160 using end-user devices 150. As another example, development system 120 may obtain software images remotely over a network 160 from software registry 170.

In general, elements of computing environment 100, such as “systems,” “servers,” “services,” “registries,” “devices,” “clients,” “networks,” and any components thereof (e.g., 120, 130, 140, 150, 160, and 170 of FIG. 1), may include electronic computing devices operable to receive, transmit, process, store, or manage data and information associated with computing environment 100. As used in this disclosure, the term “computer,” “processor,” “processor device,” or “processing device” is intended to encompass any suitable processing device. For example, elements shown as single devices within computing environment 100 may be implemented using a plurality of computing devices and processors, such as server pools comprising multiple server computers. Further, any, all, or some of the computing devices may be adapted to execute any operating system, including Linux, other UNIX variants, Microsoft Windows, Windows Server, Mac OS, Apple iOS, Google Android, etc., as well as virtual machines adapted to virtualize execution of a particular operating system, including customized and/or proprietary operating systems.

Further, elements of computing environment 100 (e.g., 120, 130, 140, 150, 160, and 170 of FIG. 1) may each include one or more processors, computer-readable memory, and one or more interfaces, among other features and hardware. Servers may include any suitable software component or module, or computing device(s) capable of hosting and/or serving software applications and services, including distributed, enterprise, or cloud-based software applications, data, and services. For instance, in some implementations, development system 120, application servers 130, external services 140, software registry 170, and/or any other sub-system or component of computing environment 100, may be at least partially (or wholly) cloud-implemented, web-based, or distributed for remotely hosting, serving, or otherwise managing data, software services, and applications that interface, coordinate with, depend on, or are used by other components of computing environment 100. In some instances, elements of computing environment 100 (e.g., 120, 130, 140, 150, 160, and 170 of FIG. 1) may be implemented as some combination of components hosted on a common computing system, server, server pool, or cloud computing environment, and that share computing resources, including shared memory, processors, and interfaces.

While FIG. 1 is described as containing or being associated with a plurality of elements, not all elements illustrated within computing environment 100 of FIG. 1 may be utilized in each alternative implementation of the present disclosure. Additionally, one or more of the elements described in connection with the examples of FIG. 1 may be located external to computing environment 100, while in other instances, certain elements may be included within or as a portion of one or more of the other described elements, as well as other elements not described in the illustrated implementation. Further, certain elements illustrated in FIG. 1 may be combined with other components, as well as used for alternative or additional purposes in addition to those purposes described herein.

Software applications 110, such as those developed and deployed in example computing environment 100, are becoming increasingly sophisticated. As software applications 110 become more sophisticated, their complexity also increases, along with the number and variety of underlying components 115. Many modern software applications 110, for example, may be composed of a variety of underlying components 115. A microservices application 110, for example, may include many different microservices 115. Similarly, applications 110 implemented using software containers may include many different software containers and associated container images. A containerized microservices application 110, for example, may include numerous microservice containers (e.g., software containers for each microservice 115) and associated container images (e.g., container images for each microservice 115 container).

Developing a complex software application 110 may be challenging, as its numerous components 115 must each be developed, configured, tested, and maintained or updated. Development of an application 110, for example, may involve multiple separate development teams and/or entities that are each responsible for developing different components 115. Moreover, because the various components 115 of the application 110 may be developed by different development teams and/or entities, new versions of each underlying component 115 may be developed independently, and thus the timing and frequency of new version releases may vary for each underlying component 115 of the application 110. In addition, new versions of the underlying components of the application 110 may not necessarily be compatible with the application 110 itself, depending on the extent of the changes. Accordingly, ensuring that the components of an application 110 are updated with the latest compatible versions may be challenging. Testing a complex software application 110 may also be challenging, as it may involve numerous complex tests, using many different test cases and use cases, of both the underlying components 115 individually and the application 110 as a whole. Creating the test cases for testing an application 110 may itself be a complex and time-intensive undertaking.

Configuring a complex software application 110 may also be challenging, particularly as the number of underlying components 115 increases, as it may involve tailored configurations of each component of the application. A microservices application 110, for example, may require tailored configurations for each underlying microservice 115 or microservice container 115. Moreover, because the various components 115 of an application 110 may be developed by different development teams and/or entities, the manner of configuring each component may vary. For example, each component 115 may be configured using different configuration mechanisms, including configuration software, configuration files, configuration documentation, command-line arguments, and environment variables, among other examples. Accordingly, ensuring that the software components 115 of an application 110 are properly configured may be challenging.

Creating a containerized microservices application 110, for example, may require determining container dependencies and tailoring the configuration (e.g., start-up parameters) for each microservice container to ensure that the underlying microservices 115 cooperate together as a fully functioning microservices application 110. Existing solutions require the developer to prowl through documentation for each microservice 115 container, or read code if no documentation is provided, and manually tailor the configuration of each microservice 115, including their command-line arguments and/or tools, runtime environments, and deployment environments. This manual approach may be performed directly, or using scripting and release automation tools (e.g., Ansible, Chef, or Puppet) that may require configuration scripts to be written. For example, configuration parameters may be set using a text-based approach, such as by directly editing configuration files (e.g., files in a YAML or JSON format) or using a web-based editor to indirectly edit the same configuration format. This requires developers to learn new configuration formats, and different formats for different tools, in order to deploy a microservices application 110. This configuration approach is time-consuming, error-prone, and subject to change when migrating applications 110 from one deployment environment to another.

In some embodiments, runtime-based application configuration functionality may be used to facilitate configuration of applications 110. Configuring a microservices application 110, for example, may be performed using introspection, which may involve monitoring the application and its microservice containers during runtime (e.g., during application or container startup and/or for a period of time thereafter). Runtime monitoring may be used to learn and gather information about the environment in which the containerized application 110 expects to run. The runtime environment information may be derived, for example, by monitoring network traffic, filesystem access, access to particular environment variables or command-line arguments, and/or any other runtime activities or characteristics of the application 110. The runtime environment information may be used to configure the microservices application 110, for example, by identifying and configuring resources used by the microservices application 110. These microservices resources may include, for example, additional or dependent microservice containers, filesystem volumes, external resources, and so forth. In some embodiments, when dependent microservice resources are identified, the runtime monitoring process may then be repeated to configure those dependent microservice resources until the application 110 is fully configured. In some embodiments, the completed configuration for the microservices application 110 may be stored using a vendor-agnostic format containing all information needed for deployment, including configurations for the underlying microservice containers, external resources, other microservice resources, runtime environments, and deployment environments. Using a vendor-agnostic format may facilitate migration of the application 110 across deployment environments, for example, by converting the vendor-agnostic format into the appropriate vendor-specific format for the particular deployment environment. In some embodiments, runtime monitoring may also be used to improve security, for example, by identifying suspicious activity and/or attempts to access insecure resources.

This runtime-based application configuration approach may be used for any type of application or software, including both microservices applications and monolithic applications, among others. Runtime-based application configuration provides many benefits, including helping development and operations (or DevOps) engineers efficiently configure and maintain complex software applications 110, such as microservices applications. It also increases the ability to work in various deployment environments and migrate applications from one deployment environment to another, as needed. Runtime-based application configuration avoids prowling through configuration documentation, manually configuring components (e.g., microservice containers), and/or subsequently reconfiguring those same components (e.g., when migrating an application across deployment environments). Less knowledge about configuration of the underlying components or microservice containers is required, allowing developers to focus on application development rather than configuration details and mechanics. Security is also improved with minimal overhead, for example, from simultaneously monitoring for suspicious activity while the application's runtime environment is being monitored for configuration purposes. In this manner, runtime-based application configuration may significantly enhance the software development process, as it saves time, minimizes errors (e.g., from error-prone manual configurations), and reduces the overall burden of managing complex software applications 110 (e.g., microservices applications).

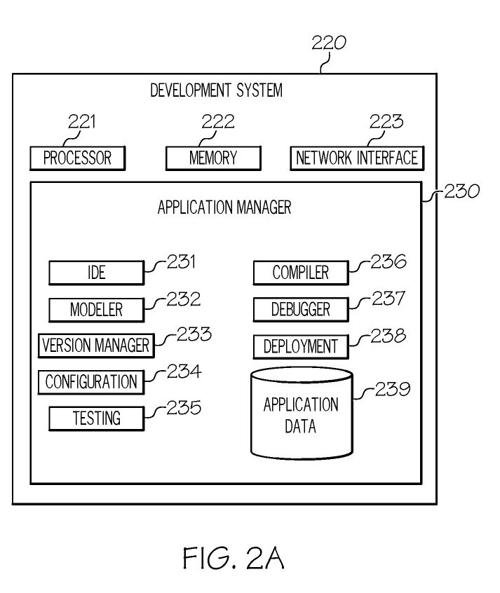

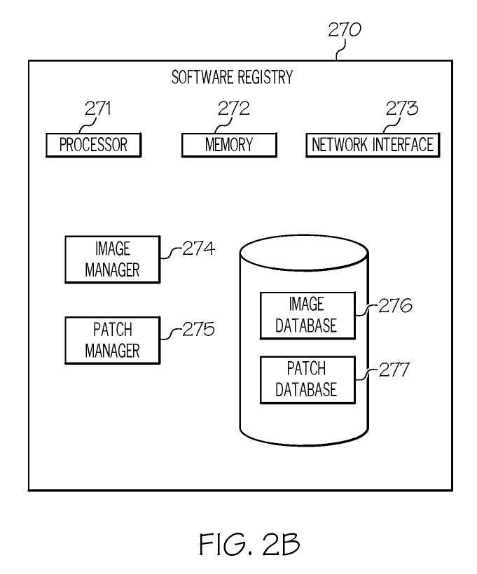

FIG. 2A illustrates a simplified block diagram of an example software development system 220. In some embodiments, software development system 220 may include functionality for runtime-based application configuration, as described throughout this disclosure.

Software development system 220 may facilitate development, testing, deployment, and/or maintenance of software, such as software applications, programs, libraries, modules, or other software components (e.g., components of larger, multi-tiered software systems). In some embodiments, for example, software development system 220 may be used to implement the functionality of software development system 120 of FIG. 1. In certain embodiments, software development system 220 may include one or more processors 221, memory elements 222, and network interfaces 223, along with application development software, such as application manager 230. In some implementations, the various illustrated components of development system 220, and other associated systems and tools, may be combined, or even further divided and distributed among multiple different systems. For example, in some implementations, development system 220 may be implemented as multiple different systems with varying combinations of the foregoing components (e.g., 221, 222, 223, 230). Components of development system 220 may communicate, interoperate, and otherwise interact with external systems and components (including with each other in distributed embodiments) over one or more networks using network interface 223.

Application manager 230 may include a collection of components, functionality, and/or tools for facilitating development of software applications (e.g., application 110 of FIG. 1). For example, in some embodiments, application manager 230 may include integrated development environment (IDE) 231, application modeler 232, version manager 233, configuration module 234, testing module 235, compiler 236, debugger 237, deployment module 238, and/or application data storage 239, among other potential components, functionality, and tools (along with any combination or further division, distribution, or compartmentalization of the foregoing). In some embodiments, application manager 230, and/or its underlying components, may be implemented using machine executable logic embodied in hardware- and/or software-based components.

In some embodiments, an integrated development environment (IDE) 231 may be included to provide a comprehensive development environment for software developers. IDE 231, for example, may be a software development application with a user interface that integrates access to a collection of software development tools and functionality. For example, IDE 231 may integrate functionality for source code editing, intelligent code completion, application modeling, graphical user interface (GUI) building, version management and control, configuration, compiling, debugging, testing, and/or deployment. The boundary between an integrated development environment (e.g., IDE 231) and other components of the broader software development environment (e.g., software development system 220) may vary or overlap. In some embodiments, for example, IDE 231 may provide an interface that integrates the various components and tools of application manager 230, such as application modeler 232, version manager 233, configuration module 234, testing module 235, compiler 236, debugger 237, and/or deployment module 238.

In some embodiments, an application modeler 232 may be provided to model the architecture of a software application. Software applications may be composed of, include, and/or rely on a variety of underlying software components. For example, applications may be implemented using a variety of software design approaches (e.g., monolithic or microservices architectures), and with a variety of software modules, components, containers, services, microservices (e.g., microservices 115 of FIG. 1), and/or external services (e.g., external services 140 of FIG. 1), among other examples. Microservices applications, for example, may be implemented by packaging a variety of microservices into separate software containers. Application modeler 232 may be used to design, configure, and/or update the architecture of a software application and its underlying components. For example, application modeler 232 may be used to design or configure an application by identifying each underlying component, along with its functionality and responsibilities, configuration, version, and relationship to other components, among other information. This configuration information for the application may be stored by the application modeler 232, for example, using application data storage 239. Application modeler 232 may also display a graphical representation of the application's design or architecture. For example, application modeler 232 may display graphical representations of each underlying software component of the application (including, for example, the name, version, and/or configuration of each component), the relationships between the underlying components, and so forth. In addition, in some embodiments, application modeler 232 may also provide or facilitate runtime-based application configuration, for example, as described in connection with configuration module 234.

In some embodiments, a compiler 236 may be provided to compile and/or build applications, for example, by compiling the source code of an application developed using development system 220. In some embodiments, a debugger 237 may also be provided to debug applications that are developed using development system 220.

In some embodiments, a testing module 235 may be provided to test software applications that are developed using development system 220. Testing an application may involve numerous complex tests, using many different test cases and use cases, of both the underlying components individually and the application as a whole. Creating the test cases for testing an application may itself be a complex and time-intensive undertaking. In some embodiments, testing module 235 may include model-based testing functionality to facilitate application testing.

In some embodiments, a deployment module 238 may also be provided to deploy applications that are developed using development system 220. For example, once an application has been developed, deployment module 238 may be used to deploy the application for live use by end-users. In some embodiments, for example, deployment module 238 may deploy the application on one or more live production servers, such as application servers 130 of FIG. 1.

In some embodiments, application data storage 239 may be used to store information associated with applications developed using development system 220, such as source code, configurations, version information, application models, and testing models, among other examples.

In some embodiments, a version manager 233 may be provided to facilitate version control and management for software applications. For example, version manager 233 may include a version control system. Version control systems, for example, may be used by software developers to manage changes to software, simultaneously work on different aspects and/or versions of the software, and recover previous versions of the software when needed. For example, version control systems may record the changes to files over time, allowing developers to revert files back to a previous state, revert an entire project back to a previous state, compare changes over time, identify authors and dates for particular files and/or revisions, and so forth. Version manager 233 may also be used to manage updates to the various packages used by software applications. For example, a software application may rely on a variety of existing software packages or components, including software libraries or environments, application programming interfaces (APIs), other software applications or components (e.g., database servers, web servers), and operating systems, among other examples. During development of a software application, development system 220 may obtain the appropriate software packages for building the application, for example, from a software registry (e.g., software registry 170 of FIG. 1, software registry 270 of FIG. 2B). Throughout the life of the application, new versions of the underlying software packages used by the application may be released (e.g., new versions, releases, updates, patches, bug fixes, or any other revisions). Version manger 233 may facilitate updating the software application, when appropriate, with new versions of its underlying software packages.

In some embodiments, a configuration module 234 may be provided to configure applications that have been developed, or are being developed, using software development system 220. For example, configuration module 234 may be used to configure underlying software components, software containers (e.g., Docker containers, Open Container Initiative (OCI) based containers, and/or any other software container implementation), microservices, microservice containers, software images, databases, web servers, external services, network connections, filesystems, runtime environments, and deployment environments of an application, among other examples.

For example, creating a containerized microservices application may involve identifying the container dependencies and tailoring the configuration of each microservice container to ensure that the underlying microservices cooperate together as a fully functioning microservices application. Moreover, because the various microservices of an application may be developed by different development teams and/or entities, the manner of configuring each microservice or microservice container may vary. For example, each microservice container may be configured using different configuration mechanisms, including various types of configuration software, configuration files, configuration documentation, command-line arguments, and environment variables, among other examples. Existing solutions require the developer to prowl through documentation for each microservice container, read code if no documentation is provided, and manually tailor the configuration of each microservice container. Accordingly, in some embodiments, configuration module 234 may include functionality for automatically configuring applications. For example, configuration module 234 may automatically configure certain aspects of an application by inspecting the application and its associated components (e.g., source code, application models, configuration files), obtaining configuration information from external sources, obtaining information from developers or operators, and/or monitoring the application during startup or runtime.

In some embodiments, for example, configuration module 234 may include runtime-based application configuration functionality to facilitate or automate application configuration. Runtime-based application configuration functionality may facilitate application configuration using introspection, which may involve monitoring the application during startup or runtime to infer or derive its configuration. For example, configuration module 234 may configure a microservices application by monitoring the application and its microservice containers during runtime, such as during application or container startup and/or for a period of time thereafter. Runtime monitoring may be used to learn and gather information about the environment in which the containerized application expects to run (e.g., based on network traffic, filesystem access, access to particular environment variables or command-line arguments, and so forth). The runtime environment information may then be used to configure the microservices application, for example, by identifying and configuring resources used by the microservices application. These microservices resources may include, for example, additional or dependent microservice containers, filesystem volumes, external resources, and so forth.

In some embodiments, for example, an initial microservice container of a microservices application may be launched and monitored. If a dependent microservice resource is identified based on the runtime monitoring process (e.g., an additional microservice container), the dependent microservice resource may then be configured using the same runtime monitoring process, and this configuration process may continue for each additional microservice resource that is identified, until the application is fully configured. For example, during runtime monitoring of a microservices application, if it is determined that microservice container A relies on or uses microservice container B (e.g., a WordPress container relies on an SQL container), microservice B may then be configured, for example, by launching microservice B or restarting the microservices application to launch microservices A and B together. The runtime environment of both microservices A and B may continue being monitored to identify additional microservice resources, until the microservices application is fully configured (e.g., until no additional microservice resources are identified).

As an example, a microservices application may be created based on a WordPress container. The WordPress container, however, may require a connection to an SQL database container in order to function properly, such that the WordPress container may fail during startup if it is launched in isolation. When configuring the application using runtime-based configuration functionality, the WordPress container may be launched, an attempt by the WordPress container to connect to an SQL database may be detected, and the WordPress container may then fail during startup if there is no SQL database container running. Thus, an SQL database container may then be chosen and/or configured, and the microservice application may then be restarted by launching both the WordPress container and the SQL container, and monitoring the runtime environment of those containers to determine if any other microservice containers or resources are needed.

In some cases, when it is determined that an additional microservice container needs to be configured, there may be a variety of possible microservice containers that provide the requisite functionality. For example, if it is determined that an SQL container is needed, there may multiple possible SQL containers to choose from (e.g., MySQL and MariaDB, among others). In some embodiments, the various options of possible microservice containers may be presented for selection by the developer (e.g., presented by configuration module 234). In addition, or alternatively, options may be presented to the developer for suggested, preferred, and/or default containers from the available microservice containers. In some embodiments, a user interface may be provided to facilitate selection and configuration of microservice containers.

In some embodiments, monitoring the runtime of an application may include monitoring network traffic, filesystem access, access to particular environment variables or command-line arguments, and/or any other runtime activities or characteristics of the application. This runtime environment information may then be used to derive or infer a configuration for the application. For example, one facet of this is monitoring may include monitoring the network traffic on the interface(s) in the network namespace of the microservice containers. Analysis of the monitored network traffic may reveal a collection of IP addresses, DNS names, port numbers, and other network information or activity associated with the application. This network information may be used, for example, to determine what connections the application is attempting to make. The network traffic information may then be used in connection with other sources of information (e.g., Internet port number registries, container registries, and/or various other sources of network information) to determine if the network activity and attempted connections are intended for other microservice containers, external resources, third party Internet sites, and/or other microservice resources. The appropriate microservice resources may then be configured and/or launched. Similarly, filesystem access may also be monitored, for example, to derive configurations for any filesystems used by the application. For example, if a microservice container attempts to write to a file, a filesystem volume may be created to ensure that the data written to the file persists. Similarly, if a microservice container attempts to read from a particular file, an existing filesystem volume containing that file may be mounted. If a microservice container attempts to access particular environment variables and/or command-line arguments, values for those parameters may be supplied.

In some embodiments, a database or repository of information associated with existing applications may be built to facilitate the process of deriving an application's configuration from its runtime environment. The configuration repository may include, for example, information about software containers, software container configurations, Internet port numbers, and/or any other information about existing applications or microservices. In some embodiments, the configuration repository may be implemented by or with a software registry, such as software registry 270 of FIG. 2A. The configuration repository may facilitate application configuration, for example, by correlating the runtime activity of an application with the stored information associated with existing applications. For example, the configuration repository may identify the type of service or application typically associated with various network ports, along with various specific applications that provide that type of service. For example, the configuration repository may indicate that port 3306 is associated with mySQL databases, and the repository may also identify and/or store all applications that provide mySQL databases. The repository may be built, for example, by identifying all container images that expose port 3306 (e.g., based on a search of a container repository such as Dockerhub), and then using the configuration repository to store those container images and identify them as images that provide mySQL databases. In addition, in some embodiments, the configuration repository may also identify collections of related or dependent container images. For example, a WordPress container image may be identified as related to or dependent upon an SQL container image, since a WordPress container may require an SQL database in order to function properly.

In some embodiments, the complete configuration for the application may be stored using a vendor-agnostic format containing all information needed for deployment, including configurations for the underlying microservice containers, external resources, other microservice resources, runtime environments, and deployment or orchestration environments. Use of the vendor-agnostic format may facilitate deployment and migration of the application across deployment environments, for example, by converting the vendor-agnostic format into the appropriate vendor-specific format for a particular deployment environment. For example, various orchestration tools and/or orchestration environments may be used to facilitate or automate deployment, scaling, and/or operations of containerized applications, such as the orchestration environments provided by Kubernetes, Docker Swarm, and/or Apache Mesos, among other orchestration tools. In some embodiments, the vendor-agnostic configuration for the microservices application may be used to generate a vendor-specific configuration for the particular orchestration environment used to deploy the application (e.g., generating a Kubernetes configuration from the vendor-agnostic configuration). If the microservices application is deployed or migrated to a new deployment environment, a vendor-specific configuration for the new environment may similarly be generated using the vendor-agnostic configuration, eliminating the need to separately configure different deployment or orchestration environments used for a microservices application.

In some embodiments, runtime monitoring may also be used to improve security with minimal additional overhead, for example, by simultaneously monitoring for suspicious or unnecessary activity while the application's runtime environment is being monitored for configuration purposes. For example, while the runtime environment of a microservice container of an application is being monitored, any suspicious or unnecessary activity by the microservice container may be identified (e.g., attempts to access insecure resources). As an example, local connections to resources on the same network may be more trustworthy than remote connections to external resources on other networks, and thus local connections may require less scrutiny than remote or external connections. In some cases, local connections may be differentiated from remote connections based on how the connection is established. For example, local connections are typically created using hostnames that identify local resources on the same network, while remote connections are typically created using fully qualified domain names. Thus, an attempt to connect to a hostname on a local network may be allowed, while an attempt to connect to a fully qualified domain name may be scrutinized more closely. For example, an external connection to a Google or Microsoft mapping API may be allowed, but an external connection to an unknown server in another country may be flagged as suspicious or unnecessary.

In some embodiments, the suspicious or unnecessary activity may be reported to a user or developer, the activity may be blocked, the microservice container may be updated (e.g., to patch a security vulnerability), the microservice container may be replaced with another container that provides equivalent functionality, and/or the microservice container may be reconfigured to replace an insecure microservice resource with another more secure microservice resource (e.g., reconfiguring an external resource used by a microservice container with a different and more secure external resource). In this manner, a user or developer may determine whether the activity is unnecessary or possibly malicious, and the appropriate remedial action may be taken. For example, a decision to block the suspicious or unnecessary activity may be specified in the vendor-agnostic configuration for the application, and then any subsequently generated vendor-specific configuration for the application may be configured to filter the undesirable activity. In a Linux environment, for example, the Linux kernel firewall may be configured to block or filter undesirable network activity (e.g., using the Linux iptables tool or an equivalent tool).

The runtime-based application configuration functionality described in connection with FIG. 2A may be used to facilitate software development and configuration (and security) for any type of application or software, including both microservices applications and monolithic applications, among others, as described throughout this disclosure.

FIG. 2B illustrates a simplified block diagram of an example software registry 270. Software registry 270 may host a repository of software packages that can be used by or used with a particular software application (e.g., application 110 of FIG. 1), including software libraries or environments, application programming interfaces (APIs), other software applications or components (e.g., database servers, web servers), and operating systems, among other examples. In some embodiments, for example, software registry 270 may be used to implement the functionality of software registry 170 of FIG. 1. In certain embodiments, software registry 270 may include one or more processors 271, memory elements 272, and network interfaces 273, along with software registry management software, such as image manager 274 and patch manager 275, and software registry databases, such as image database 276 and patch database 277. In some implementations, the various illustrated components of software registry 270, and other associated systems and tools (e.g., development system 220 of FIG. 2A), may be combined, or even further divided and distributed among multiple different systems. For example, in some implementations, software registry 270 may be implemented as multiple different systems with varying combinations of the foregoing components (e.g., 271, 272, 273, 274, 275, 276, 277). In addition, some or all of the components of software registry 270 may be implemented as part of software development system 220 of FIG. 2A. Components of software registry 270 may communicate, interoperate, and otherwise interact with external systems and components (including with each other in distributed embodiments) over one or more networks using network interface 273.

In some embodiments, an image manager 274 may be used to manage and distribute software images corresponding to various software packages hosted by software registry 270. For example, software applications (e.g., application 110 of FIG. 1) can be developed using a variety of existing software packages, and software registry 270 may host a repository of software packages that can be used by or used with those software applications. Software packages hosted by software registry 270 may be stored, in some embodiments, using software images corresponding to particular software packages. As an example, software packages that are implemented using software containers may be stored in software registry 270 using container images (i.e., images that include all components and dependencies required to run a particular software package in a software container, such as a microservice). In some embodiments, image database 276 may be used to store the software images associated with the software packages hosted by software registry 270. During development of an application, the appropriate software packages for building or updating the application may be retrieved from software registry 270. In addition, throughout the life of the application, any new versions, releases, updates, patches, bug fixes, or other revisions to those associated software packages may also be retrieved from software registry 270. For example, a software development system (e.g., development system 220 of FIG. 2A) may need to retrieve various software packages used by a software application that is under development on the software development system. Accordingly, the software development system may request the appropriate software packages from software registry 270. In some embodiments, image manager 274 may be used to retrieve the appropriate software images from image database 276 and distribute those software images (e.g., over a network) to the requesting software development system. In addition, in some embodiments, a patch manager 275 may be used to manage and distribute software patches associated with software packages hosted by software registry 270.

In some embodiments, software registry 270 may also be used to host a database or repository of information associated with existing software or applications, for example, to facilitate the runtime-based application configuration functionality described throughout this disclosure (e.g., the configuration functionality described for configuration module 234 of FIG. 2A). This configuration repository may include, for example, information about software containers, software container configurations, Internet port numbers, and/or any other information about existing software, applications, and/or microservices. The configuration repository may facilitate application configuration, for example, by correlating the runtime activity of an application with the stored information associated with existing applications, as described throughout this disclosure.

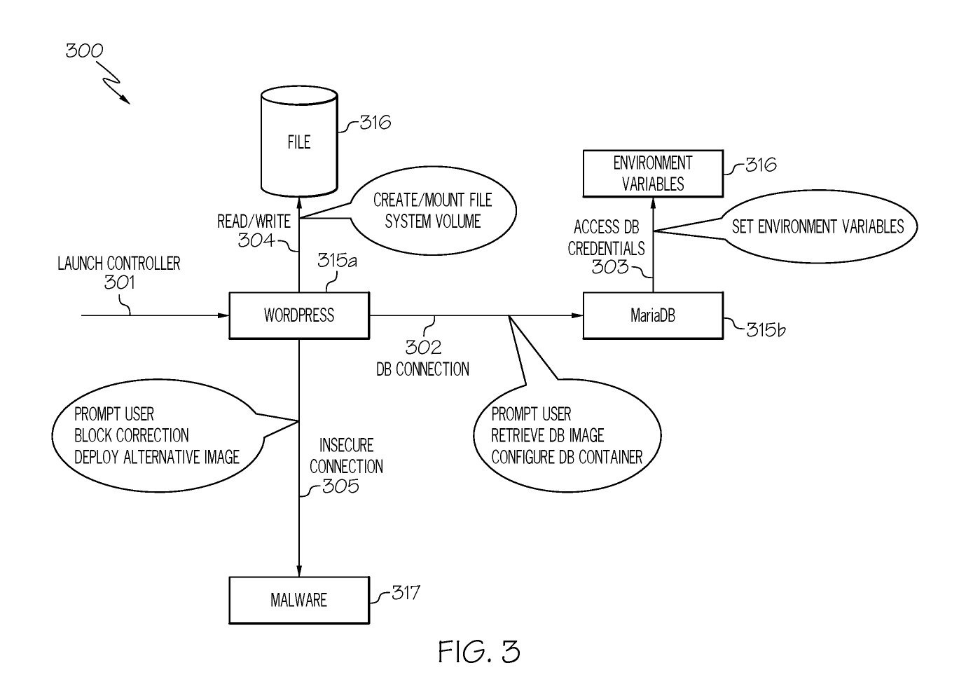

FIG. 3 illustrates an example 300 of runtime-based configuration for an application. The application may be a microservices application used for blogging, for example, which uses a WordPress container 315a to provide the blogging functionality.

In the illustrated example, the configuration begins by launching the WordPress container 315a used by the microservices application (action 301), and then the runtime environment of the WordPress container may be monitored. Because the WordPress container 315a may rely on an SQL database for storing the blog content, it may attempt to connect to an SQL database (action 302). The connection attempt may be identified during the runtime monitoring, and if no SQL database is running, the WordPress container may fail, and it may be determined that an SQL database container needs to be configured. The user or developer may be prompted with options of potential SQL database container images. In the illustrated embodiment, a MariaDB container 315b is chosen to provide the SQL database. The MariaDB container image may then be retrieved and configured, and the microservices application may be restarted by launching both the WordPress container 315a and the MariaDB container 315b. The runtime environment of both containers may continue being monitored to determine if any other microservice containers or resources are needed.

The MariaDB container 315b may then attempt to obtain authorization credentials for its SQL database by attempting to access environment variables 316 used by MariaDB for specifying database authorization credentials (action 303). The attempt to access the environment variables may be identified by the runtime monitoring, and since the variables are not set, they may then be set using the appropriate authorization credentials. In some embodiments, the user or developer may be prompted to supply the authorization credentials. The microservices application may then be restarted, and the runtime environment of the containers may continue being monitored to determine if any other microservice containers or resources are needed.

The WordPress container 315a may then attempt to access a file 316 (action 304). If the container attempts to write to a file, for example, a filesystem volume may be created to ensure that the data written to the file persists. If the container attempts to read from a file that is known to be stored on an existing filesystem volume, that filesystem volume may be mounted.

The WordPress container 315a may then attempt to create a connection to an external resource (action 305), which may be known to be malware 317. The insecure connection attempt may be reported to a user or developer, allowing the user or developer to determine whether the activity is unnecessary or possibly malicious, and choose an appropriate remedial action. For example, the connection attempt may be blocked, the WordPress container may be updated (e.g., to patch a security vulnerability), and/or the WordPress container may be replaced with another container that provides equivalent functionality.

At this point, if no further microservice resources are identified while monitoring the runtime environment of the application, the runtime-based configuration of the application may be complete.

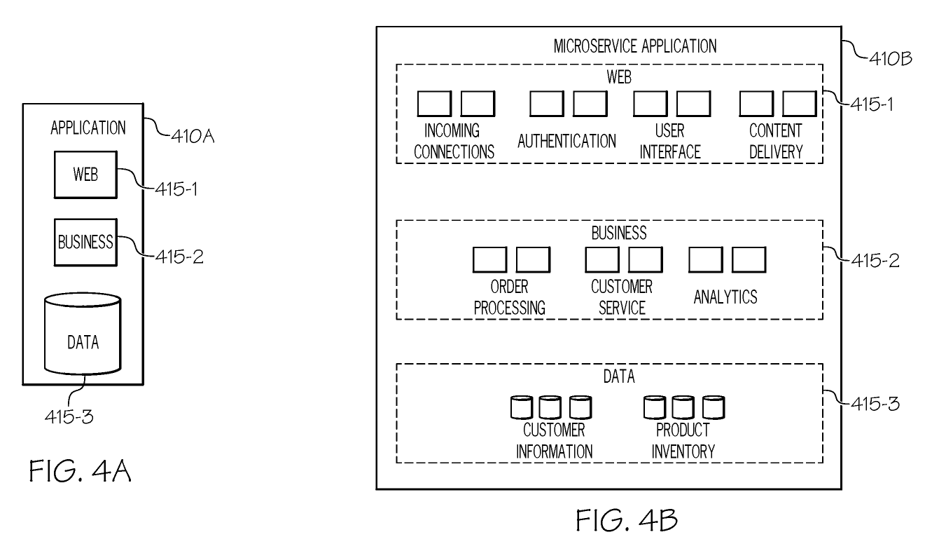

FIGS. 4A and 4B illustrate example monolithic and microservices architectures for a software application. Software applications can be implemented using many different software design approaches, including monolithic-based architectures and microservice-based architectures. FIG. 4A illustrates an example monolithic architecture for a software application, and FIG. 4B illustrates an example microservices architecture for the same software application.

A monolithic application, for example, may be implemented as a single application that integrates all associated components and functionality. While a monolithic application may have a logically modular architecture, it is packaged and deployed as one large application. For example, in FIG. 4A, monolithic application 410A is a single application with multiple logical components 415, including web logic 415-1, business logic 415-2, and data storage logic 415-3. Monolithic applications are very common, as they are straightforward to develop since many development tools (e.g., IDEs) focus on building single applications. Monolithic applications are also simple to test. End-to-end testing can be performed by simply launching the application and testing the user interface (e.g., using testing software). Monolithic applications are also simple to deploy—the complete application package can simply be copied to an application server and launched.

Monolithic approaches may work well in the early stages of an application and for smaller applications. Many applications, however, grow over time and eventually become highly complex. Accordingly, monolithic applications may be inefficient to develop and maintain, as they are often too complex for any single developer to fully understand, making simple tasks such as bug fixes and feature updates very difficult. In addition, any updates to the application, even if minor, often require the entire application to be tested and redeployed. Monolithic applications also make it difficult to adopt new programming languages, frameworks, or other new software technologies. Rewriting a large, complex application (e.g., with millions of lines of code) using a new technology is often impractical, leaving developers stuck with the original technologies that were chosen at the outset. Monolithic applications can also be unreliable. Because all functionality is running within the same process, any minor bug (e.g., memory leak) or hardware failure can be fatal to the entire application. Continuous deployment may also be challenging for monolithic applications. Continuous deployment is a software development trend to continuously push new changes into production rather than sporadically release new functionality, which can be very difficult for monolithic applications since the entire application must be redeployed when any aspect is updated. Scaling monolithic applications efficiently may also be challenging, as it requires instances of the entire application to be deployed, even if only one aspect of the application needs to be scaled. In addition, monolithic applications are often deployed on hardware that is pre-scaled for peak loads. When a monolithic application outgrows its hardware, the hardware may have to be “scaled up” or upgraded rather than reconfiguring the datacenter and/or updating the software architecture of the application.

Even if the web, business, and data logic of a monolithic application is decomposed into separate applications to provide some level of developer agility and independent scaling, each logical tier often becomes its own separate monolithic application that integrates diverse functionality into a single software package, and thus may still suffer from challenges faced by monolithic applications.

While monolithic architectures may be suitable for certain types of applications, microservice-based architectures may be preferable for large, complex applications that require flexible development, deployment, and scaling (e.g., cloud-based applications). A microservices application, for example, may be implemented using multiple separate and self-contained applications, or microservices, that each provide a particular service and collectively form a fully functional application. A microservices architecture may allow each underlying microservice of an application to be independently developed, deployed, updated, and scaled, resulting in numerous efficiencies in the software development process.

For example, in FIG. 4B, microservices application 410B includes a variety of microservices 415 to implement the web logic, business logic, and data storage logic. For example, the web logic is implemented using various microservices 415-1 responsible for incoming connections, authentication, the user interface, and web content delivery. The business logic is implemented using various microservices 415-2 responsible for order processing, customer service, and analytics. The data storage logic is implemented using various microservices 415-3 responsible for managing storage of customer information and product inventory. In microservice-based architectures, each discrete function or service of an application is implemented by its own microservice, and each microservice is itself an independent application. Microservices are often designed to communicate using simple and well-known communication methods and protocols, such as lightweight RESTful APIs (i.e., application programming interfaces (API) implemented using representational state transfer (REST) architectures).

Microservices applications can be developed and maintained more efficiently, as complex applications are broken up into multiple smaller and more manageable applications, or microservices. The functionality of each microservice often is so focused that a particular microservice can be used for multiple different applications. Microservice-based architectures also enable the underlying microservices to be developed independently by different software development teams. Microservices can be developed using the most appropriate programming language and/or technology for each microservice, rather than being stuck with obsolete technologies or technologies that may only be suitable for certain types of microservices. The independent, distributed nature of microservice-based applications also enables them to be independently deployed and independently updated. In addition, microservice-based architectures facilitate rolling updates, where only some instances of a particular microservice are updated at any given time, allowing buggy updates to be “rolled back” or undone before all instances of the microservice are updated.

Microservice-based architectures also enable each microservice to be scaled independently, resulting in more efficient load balancing. Microservices can be scaled by deploying any number of instances of a particular microservice needed to satisfy the capacity and availability constraints of that microservice. For example, if there is a spike in incoming traffic to an application, the microservice responsible for handling incoming connections could be scaled without scaling other microservices of the application. A microservice can also be deployed on the hardware that is best-suited for its respective requirements and functionality.

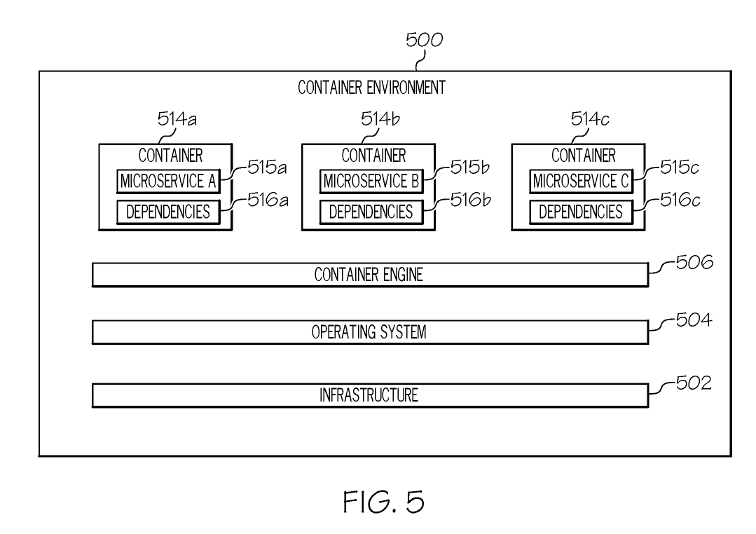

Microservices applications can be implemented using virtual machines or software containers. Software containers can be an effective complement to a microservices application, as they can be used to ensure that each microservice runs the same in any environment or infrastructure, out-of-the-box. A microservices application, for example, could be implemented using the software container environment described in connection with FIG. 5.

Microservice-based architectures are integral to various software technology advancements, including cloud-based applications and services, continuous integration and continuous deployment (Cl/CD), and software container technology, among other examples.

The runtime-based application configuration functionality described throughout this disclosure can be implemented for both microservices and monolithic architectures. For example, for microservices architectures, the runtime environment of an application may be monitored to configure the microservices, microservice containers, and/or other microservice resources of the application. Similarly, for monolithic architectures, the runtime environment of an application may be monitored to configure the various components and resources of the application.

FIG. 5 illustrates an example software container environment 500. In some cases, software applications may be implemented using software containers, such as Docker containers, containers based on the Open Container Initiative (OCI), and/or any other software container implementation. Analogous to shipping containers, software containers may package a particular software component with all of its dependencies to ensure that it runs the same in any environment or infrastructure, out-of-the-box. For example, a software container may package everything required to run a particular software component, such as the code, software libraries, configuration, files, runtime environment, and any other associated tools or applications.

Software containers enable applications to be migrated across various infrastructures and environments without any modifications or environment-specific configurations. For example, applications can be migrated to or from local workstations, development servers, test environments, and/or production environments. Software containers also enable applications to be developed using the best programming languages and tools for each application, without any internal conflicts from the requirements of different applications. Many inefficiencies of software development and deployment are eliminated with software containers, such as time spent configuring development and production environments, concerns about inconsistencies between development and production environments, and so forth. Software containers also avoid locking developers into any particular platform, software technology, and/or vendor.

Software containers running on the same machine may also share a host operating system, thus avoiding the inefficiencies of virtual machines, which each require their own guest operating system on top of the host operating system. Accordingly, in comparison to virtual machines, software containers may launch faster and use less memory.

Software components implemented using software containers may be stored as container images, which may include all components and dependencies required to run a particular software component in a software container. A container image, for example, may be a file format used to package the components and dependencies of a containerized software component. Container images may be constructed using layered filesystems that share common files, resulting in less disk storage and faster image downloads. In some cases, container images may be hosted by a software registry (e.g., software registries 170 of FIG. 1 or 270 of FIG. 2B) to provide a central repository for distributing container images to software developers. Examples of container images include Docker container images, container images based on the Open Container Initiative (OCI), and/or any other container image format. The Open Container Initiative (OCI), for example, is a collaborative effort by the software industry to develop an open, vendor-neutral, and portable implementation of software containers, to ensure that compliant software containers are portable across all major operating systems and platforms that are also compliant. The OCI implementation is based on the implementation of Docker containers.

Software container environment 500 illustrates an example of a containerized implementation for a microservices application. While microservice-based architectures have many benefits, managing the microservices of an application can become challenging as the application grows and the number of microservices increases. For example, each microservice may have unique build and configuration requirements, including its own software dependencies, which may require each microservice to be custom built and/or configured, additional software to be installed, and so forth. Accordingly, software containers can be an effective complement to a microservices application, as they can be used to ensure that each microservice runs the same in any environment or infrastructure, out-of-the-box. Software containers can be used to implement microservices applications, for example, by packaging each microservice of an application into a separate software container.

In the illustrated example, container environment 500 includes infrastructure 502, operating system 504, container engine 506, and software containers 514. Infrastructure 502 includes the underlying hardware and/or software infrastructure used to provide the containerized environment, such as an application server (e.g., application server 130 of FIG. 1). Operating system 504 is operating system software executing on infrastructure 502, which can be any operating system adapted to provide a containerized environment, such as Linux, other UNIX variants, Microsoft Windows, Windows Server, Mac OS, Apple iOS, and/or Google Android, among others. Container engine 506 includes software responsible for providing and managing the containerized environment 500, such as a Docker container engine, an OCI-based container engine, and/or any other type of software container engine. Software containers 514 are containers that execute distinct software components in their own respective environments. In the illustrated example, containers 514 each include a microservice 515 and its associated dependencies 516. For example, container 514a includes microservice A (515a) and its dependencies (516a), container 514b includes microservice B (515b) and its dependencies (516b), and container 514c includes microservice C (515c) and its dependencies (516c). These microservices 515 may collectively form a microservices application that is executing on infrastructure 502 in a containerized environment 500.

The runtime-based application configuration functionality described throughout this disclosure may be used to configure applications that are implemented in containerized environments (e.g., software container environment 500), such as a containerized microservices application.

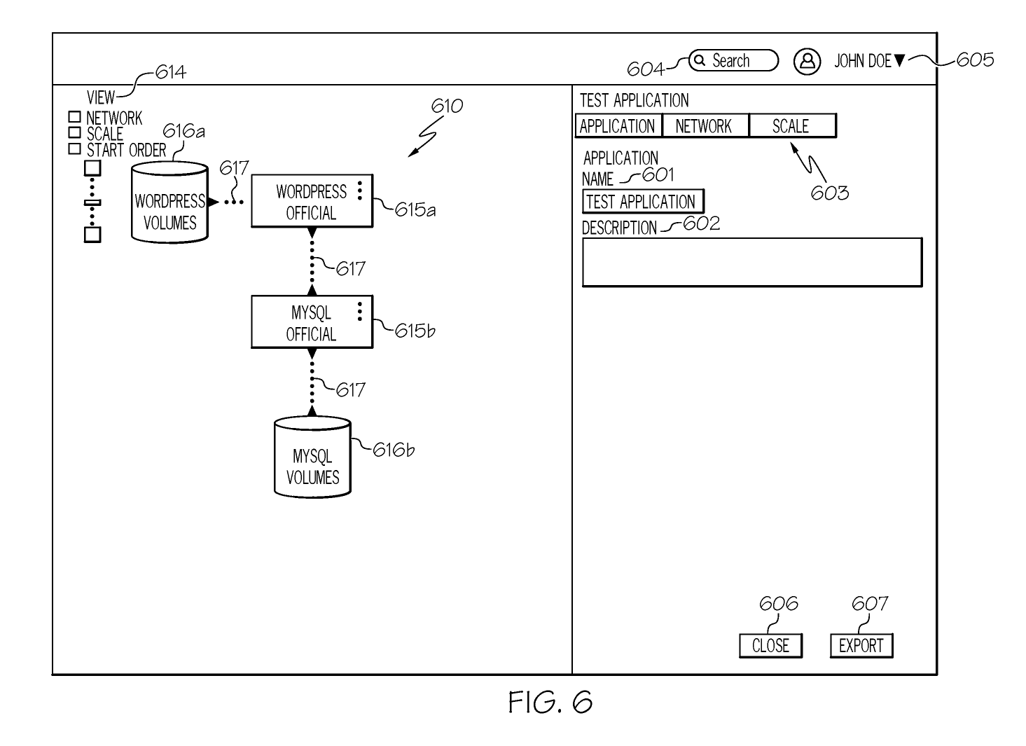

FIG. 6 illustrates an example application modeling and development tool 600. Modeling and development tool 600 may be used, for example, to provide application modeling functionality and/or other application development functionality. For example, modeling and development tool 600 may be used to model the architecture of a software application, and/or to facilitate configuration, maintenance, and/or deployment of an application. In some embodiments, for example, modeling tool 600 may be used to provide the functionality of application modeler 232 of FIG. 2A, and/or the functionality of other components of development system 220 of FIG. 2A.

Modeling tool 600 may be used to design, configure, and/or update the architecture of a software application and its underlying components. Software applications may be composed of, include, and/or rely on a variety of underlying software components. For example, applications may be implemented using a variety of software design approaches (e.g., monolithic or microservices architectures), and with a variety of software modules, components, containers, services, microservices, and/or external services, among other examples. Modeling tool 600 may be used to design or configure an application, for example, by identifying each underlying component, along with its functionality and responsibilities, configuration, version, and/or relationship to other components, among other information. This configuration information for the application may be created, obtained, stored, and/or displayed using modeling tool 600. Modeling tool 600 may display the application's design or architecture, for example, by displaying graphical representations of each underlying software component of the application (including, for example, the name, version, and/or configuration of each component), the relationships between the underlying components, and so forth.

In some embodiments, modeling tool 600 may be a tool used for modeling and/or developing microservices applications, such as the Yipee.io tool or other microservices development tool. Microservices applications, for example, may be implemented by packaging a variety of microservices into separate software containers. In the illustrated embodiment, modeling tool 600 is used to model the architecture of a microservices application 610 and its associated microservices 615. For example, modeling tool 600 displays representations of each component of application 610, including microservices 615 and storage volumes 616, and also identifies the relationships 617 among those components. Modeling tool 600 also provides various viewing options 614 for application 610, including network, scale, and start order views. Modeling tool 600 also displays modifiable configuration fields for application 610, including the name 601 and description 602 of the application, among others. In the illustrated embodiment, the configurable fields and parameters are broken up into categories 603 (i.e., the application, network, and scale categories 603). Modeling tool 600 also provides search functionality 604, identifies the current user or developer 605, and includes buttons for closing 606 and/or exporting 607 the configuration of an application 610.

In some embodiments, modeling and development tool 600 may also provide other microservices development functionality, including configuration, maintenance, and/or deployment of microservices applications. For example, modeling and development tool 600 may be used to configure the orchestration environment for a microservices application, such as an orchestration environment provided by Kubernetes, Docker Swarm, and/or Apache Mesos, among other orchestration tools. Orchestration tools, for example, may be used to facilitate and/or automate deployment, scaling, and/or operation of containerized applications.

In some embodiments, modeling tool 600 may also be used to provide and/or facilitate the runtime-based application configuration functionality described throughout this disclosure, such as the configuration functionality described in connection with configuration module 234 of FIG. 2A and/or the configuration example of FIG. 3.

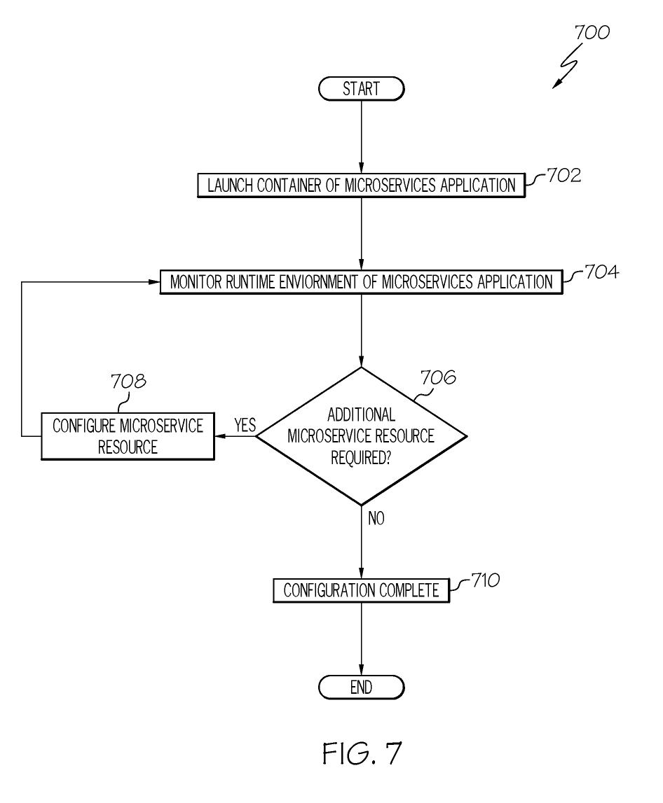

FIG. 7 illustrates a flowchart 700 for an example embodiment of runtime-based application configuration. Flowchart 700 may be implemented, in some embodiments, by the components described throughout this disclosure (e.g., development system 120 of FIG. 1 and/or development system 220 of FIG. 2A).

The flowchart may begin at block 702 by launching a microservice container of a microservices application. For example, if a microservices application is created with a WordPress container, the WordPress container may be launched.

The flowchart may then proceed to block 704 to monitor the runtime environment of the microservices application, in order to identify additional microservice resources that need to be configured for the application. In some embodiments, for example, the application runtime environment may be monitored during startup and/or a period of time thereafter. For example, network activity, filesystem access, access to environment variables, access to command-line arguments, and/or any other runtime activity or characteristic of the application may be monitored.

The flowchart may then proceed to block 706 to determine if an additional microservice resource has been identified that needs to be configured. An additional microservice resource may be identified, for example, based on the runtime environment monitoring in block 704. The additional microservice resource may be, for example, an additional microservice container, a filesystem volume, an external resource, and so forth.

If it is determined in block 706 that an additional microservice resource needs to be configured, the flowchart may then proceed to block 708, where the microservice resource may be configured, for example, based on a configuration derived by monitoring the runtime environment. For example, a configuration may be derived from network activity, filesystem access, access to environment variables, access to command-line arguments, and/or any other runtime activity or characteristic. After configuring the microservice resource, the flowchart may then proceed back to block 704, to continue monitoring the runtime environment to identify and configure additional microservice resources, in the manner described in connection with blocks 704-708.

If it is determined in block 706 that no additional microservice resources need to be configured, the flowchart may then proceed to block 710, where the configuration of the microservices application may be complete. At this point, the flowchart may be complete. In some embodiments, however, the flowchart may restart and/or certain blocks may be repeated. For example, in some embodiments, the flowchart may restart at block 702, or the flowchart may repeat blocks 704-708 in order to continue monitoring the runtime environment of the application to identify and configure additional microservice resources.

The flowcharts and block diagrams in the FIGURES illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order or alternative orders, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as suited to the particular use contemplated.

1. A method comprising:
launching a microservice container of a microservices application;
monitoring a runtime environment of the microservices application to identify one or more microservice resources to configure for the microservices application;
identifying, based on the runtime environment of the microservices application, a microservice resource to configure for the microservices application; and
configuring the microservice resource based on the runtime environment of the microservices application.

2. The method of claim 1, further comprising configuring one or more additional microservice resources until determining, based on the runtime environment of the microservices application, that configuration of the microservices application is complete.

3. The method of claim 1, wherein the microservice resource is an additional microservice container used by the microservices application.

4. The method of claim 3, further comprising restarting the microservices application to launch the additional microservice container.

5. The method of claim 3, further comprising prompting a user to select the additional microservice container from a plurality of available microservice containers.

6. The method of claim 3, wherein configuring the microservice resource based on the runtime environment of the microservices application comprises:
identifying an environment variable accessed by the additional microservice container; and
configuring the environment variable.

7. The method of claim 3, wherein configuring the microservice resource based on the runtime environment of the microservices application comprises:
identifying a command-line parameter accessed by the additional microservice container; and
configuring the command-line parameter.

8. The method of claim 1, wherein monitoring the runtime environment of the microservices application to identify one or more microservice resources to configure for the microservices application comprises monitoring network activity of the microservices application.

9. The method of claim 1, wherein monitoring the runtime environment of the microservices application to identify one or more microservice resources to configure for the microservices application comprises monitoring file system activity of the microservices application.

10. The method of claim 1, further comprising:
storing a configuration for the microservices application in a vendor-agnostic format;
identifying a deployment environment for the microservices application;
converting the configuration for the microservices application into a vendor-specific format for the deployment environment of the microservices application; and
deploying the microservices application in the deployment environment based on the configuration in the vendor-specific format.

11. The method of claim 1, further comprising:
determining that the microservices application attempted to access an insecure resource; and
blocking access to the insecure resource.

12. The method of claim 11, further comprising prompting a user whether to block access to the insecure resource.

13. The method of claim 1, further comprising:
determining, based on the runtime environment of the microservices application, that an external resource is used by the microservices application; and
configuring access to the external resource.

14. A system comprising:
a processor device;
a memory element; and
an application manager stored in the memory element, the application manager comprising one or more instructions executable by the processor device, the one or more instructions configured to:
launch a microservice container of a microservices application;
monitor a runtime environment of the microservices application to identify one or more microservice resources to configure for the microservices application;
identify, based on the runtime environment of the microservices application, a microservice resource to configure for the microservices application;
configure the microservice resource based on the runtime environment of the microservices application; and
configure one or more additional microservice resources until determining, based on the runtime environment of the microservices application, that configuration of the microservices application is complete.

15. The system of claim 14, wherein the microservice resource is an additional microservice container used by the microservices application.

16. The system of claim 15, wherein the one or more instructions are further configured to prompt a user to select the additional microservice container from a plurality of available microservice containers.

17. The system of claim 14, wherein the one or more instructions configured to monitor the runtime environment of the microservices application to identify one or more microservice resources to configure for the microservices application are further configured to monitor network activity of the microservices application.

18. The system of claim 14, wherein the one or more instructions configured to monitor the runtime environment of the microservices application to identify one or more microservice resources to configure for the microservices application are further configured to monitor file system activity of the microservices application.

19. The system of claim 14, wherein the one or more instructions are further configured to:
store a configuration for the microservices application in a vendor-agnostic format;
identify a deployment environment for the microservices application;
convert the configuration for the microservices application into a vendor-specific format for the deployment environment of the microservices application; and
deploy the microservices application in the deployment environment based on the configuration in the vendor-specific format.

20. A non-transitory computer readable medium having program instructions stored thereon that are executable to cause a computer system to perform operations comprising:
launching a microservice container of a microservices application;
monitoring a runtime environment of the microservices application to identify one or more microservice resources to configure for the microservices application;
identifying, based on the runtime environment of the microservices application, a microservice resource to configure for the microservices application;
configuring the microservice resource based on the runtime environment of the microservices application; and
configuring one or more additional microservice resources until determining, based on the runtime environment of the microservices application, that configuration of the microservices application is complete.
